(19) United States
(12) Patent Application Publication
(10) Pub. No.: US 2013/0064177 A1
(43) Pub. Date: Mar. 14, 2013

(54) PAYLOAD HEADER REDUCTION CLASSIFICATION FOR MULTIPROTOCOL CONVERGENCE SUBLAYER

(71) Applicants: Muthaiah Venkatachalam, Beaverton, OR (US); Shantidev Mohanty, Santa Clara, CA (US); Shao-Cheng Wang, Sunnyvale, CA (US)

(72) Inventors: Muthaiah Venkatachalam, Beaverton, OR (US); Shantidev Mohanty, Santa Clara, CA (US); Shao-Cheng Wang, Sunnyvale, CA (US)

(21) Appl. No.: 13/228,360

(22) Filed: Sep. 8, 2011

(51) Int. Cl. H04W 80/00; H04J 3/22; H04J 3/24

(52) U.S. Cl. 370/328; 370/474; 370/466; 370/469

(57) ABSTRACT

Embodiments of the present disclosure describe methods, apparatuses, and systems for payload header reduction classification for multiprotocol convergence sublayer.

### FIELD

Embodiments of the present disclosure generally relate to the field of wireless communication systems, and more particularly, to payload header reduction classification for multiprotocol convergence sublayer.

### BACKGROUND

In broadband mobile access technologies such as WiMAX (e.g., IEEE 802.16-2009) and Long-Term Evolution (LTE) (e.g., 3GPP Release 8), the media access control (MAC) layer defines an interface entity or classification sublayer to provide various transforming and/or mapping of external network data to the transport connections in the MAC layer. For example, WiMAX defines a service specific convergence sublayer (CS) to classify the higher layer protocol data unit (PDU) into the appropriate connection for delivery to the MAC peer. In LTE, the packet data convergence protocol (PDCP) sublayer performs similar functions by maintaining a traffic flow template (TFT) to map data packets to corresponding evolved packet system (EPS) bearers.

In IEEE 802.16m, a multiprotocol convergence sublayer has been defined to multiplex several protocols into the same traffic flow connection, such that data traffic from different upper-layer protocols can share the same quality-of-service (QoS) parameters and conserve the number of transport connections. However, there is no ability to multiplex/mix data traffic that requires different header compression or suppression schemes into the same traffic flow connection.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates a transmitter in accordance with some embodiments.

FIG. 2 illustrates a service flow connection in accordance with some embodiments.

FIG. 3 illustrates a flowchart of transmitter operations in accordance with some embodiments.

FIG. 4 illustrates a receiver in accordance with some embodiments.

FIG. 5 illustrates a flowchart of receiver operations in accordance with some embodiments.

FIG. 6 illustrates an example system capable of implementing a network device in accordance with some embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

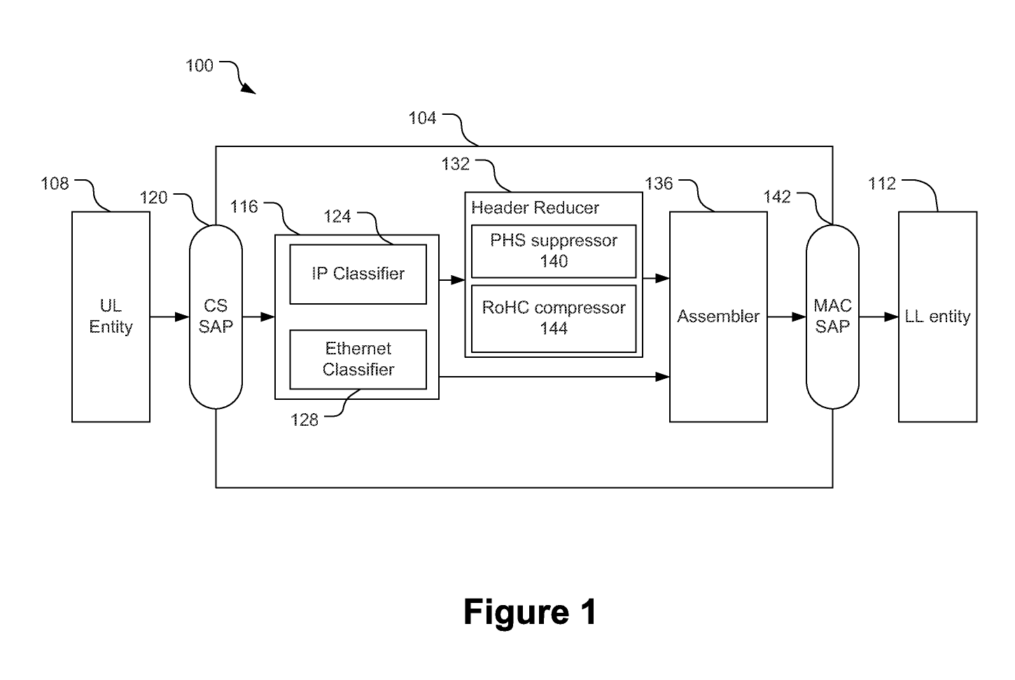

FIG. 1 illustrates a transmitter 100 in accordance with some embodiments. The transmitter 100 may include a convergence sublayer (CS) 104 that receives data units from an upper layer (UL) entity 108, maps the data units to various service flow connections, and provides the mapped data units to a lower layer (LL) entity 112. The service flow connections may be characterized by a set of quality of service (QoS) parameters such as those for latency, jitter, and throughput assurances. The UL entity 108 may be a bridge, a router, or a host. The LL entity 112 may be a MAC security layer entity that provides security layer processing.

The CS 104 may include classifiers 116 to receive, at a CS service access point (SAP) 120 that represents a CS-layer boundary, the data units as service data units (SDU). The classifiers 116 may determine a type of transmission protocol for each received SDU and provide classification processes through Internet protocol (IP) classifier 124 or Ethernet classifier 128.

The classifiers 116 may map incoming SDUs to appropriate service flow connections by referencing a variety of parameters in the SDU and comparing the parameters to predefined classification rules. The parameters may include source address, destination address, source port, destination port, etc. After mapping an SDU to an appropriate service flow connection, the classifier may append the SDU with a flow identifier (FID).

Comparing the parameters to the classification rules may also allow the classifiers 116 to determine whether a particular SDU is associated with a header reduction process. In various embodiments, the classifiers 116 will also append the SDU with a header-reduction indicator that indicates whether a header of the SDU is to be reduced and, if so, what type of reduction process is to be used. The header-reduction indicator may be used to route the SDU to a header reducer 132 or, in the event that the header will not be reduced, directly to an assembler 136.

The header reducer 132 may include a payload header suppression (PHS) suppressor 140 to implement a PHS process on headers of received SDUs. A PHS process may include the removal of header information in the SDU that may be known or otherwise discernable by the receiver or other network entities. For example, various addressing or control information may not change for a fixed communication link. Therefore, this redundant header information is not needed in all SDUs and may be removed. In various embodiments the PHS suppressor 140 may communicate with a complementary entity in a receiver to establish PHS rules for a particular communication session.

The header reducer 132 may also include a robust header compression (RoHC) compressor 144 to implement a RoHC process on headers of received SDUs. A RoHC process may involve the RoHC compressor 144, while in an initialization and refresh (IR) state, transmitting one or more packets with full headers to establish various static fields on both sides of a communication link. The RoHC compressor 144 may then transition into a first-order (FO) state in which static header fields are compressed and dynamic header fields are uncompressed. The RoHC compressor 144 may also transition to a second order (SO) state in which both the static and dynamic fields are compressed.

The assembler 136 may receive the SDUs, either from the header reducer 132 or directly from the classifiers 116, and may assemble a MAC PDU. Assembly of the MAC PDU may include appending, to a received data unit, a type identifier that may be used to identify a transmission protocol and/or an associated header-reduction process of the data unit. In some embodiments, the type identifier may be a value from 1-5 to indicate that an associated SDU has: (1) an IP transmission protocol with no header reduction; (2) an IP transmission protocol with an RoHC process; (3) an IP transmission protocol with a PHS process; (4) an Ethernet transmission protocol with no header reduction; or (5) an Ethernet transmission protocol with a PHS process. The assembly of the MAC PDU may also include other packet formation operations such as providing an encapsulating header with control and address (e.g., MAC address) information.

The assembler 136 may provide the MAC PDU to a MAC SAP 142 that may represent another CS-layer boundary.

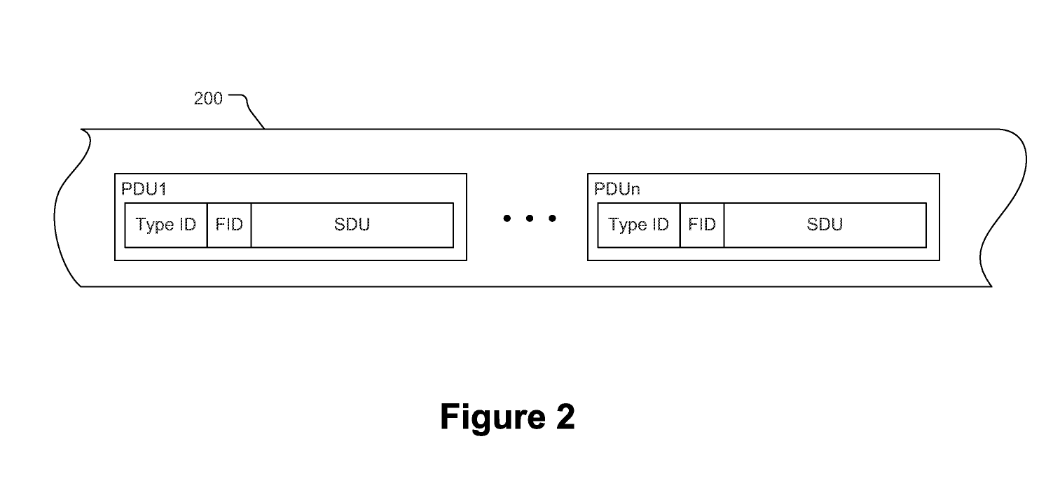

FIG. 2 illustrates a service flow connection 200 having a plurality of PDUs, e.g., PDU1, . . . , PDUn, in accordance with some embodiments. Individual PDUs may have a common FID, associating the PDU to the service flow connection 200, but may have different Type IDs. The inclusion of the Type ID enables the CS 104 to map SDUs having different transmission protocols and/or a different header reduction process to the same service flow connection, while providing a receiver with sufficient information for proper processing of the received packet.

In some embodiments, additional/alternative classification information may be communicated through dynamic service addition (DSA) and/or dynamic service change (DSC) messages, which may be communicated prior to the SDUs. For example, multiprotocol CS policy (MCP) bits, communicated in DSA/DSC messages, may provide information about header reduction for each classification rule so that the transmitter and receiver can synchronize and distinguish the appropriate header reduction processes for data traffic from different upper-layer protocols in the same service flow connection. The classification rules may be a set of criteria/parameters that function to group PDUs into different classes.

In some embodiments, the MCP bits may include two bits and may be defined as follows: if bit 0 is set to one for a classification rule, all PDUs of a service flow connection that match this classification rule shall not suppress payload headers; if bit 0 is set to zero for a classification rule, and both the receiver and transmitter support PHS, all PDUs of the service flow connection that match this classification rule shall be prefixed by a PHS index (PHSI) field; if bit 1 is set to one for a classification rule, all PDUs of the service flow connection that match this classification rule shall not compress payload headers using RoHC; and if bit 1 is set to zero for a classification rule, and both the receiver and transmitter support RoHC, all PDUs of the service flow connection that match this classification rule shall be compressed using RoHC.

Some embodiments may include an exclusion condition flag, e.g., a bit, which may be communicated through DSA/DSC messages. The exclusion condition flag may indicate whether header-reduction processes are defined on a per-classification-rule basis, by the MCP bits, or on a per-service-flow basis, by service flow level transmission policy bits.

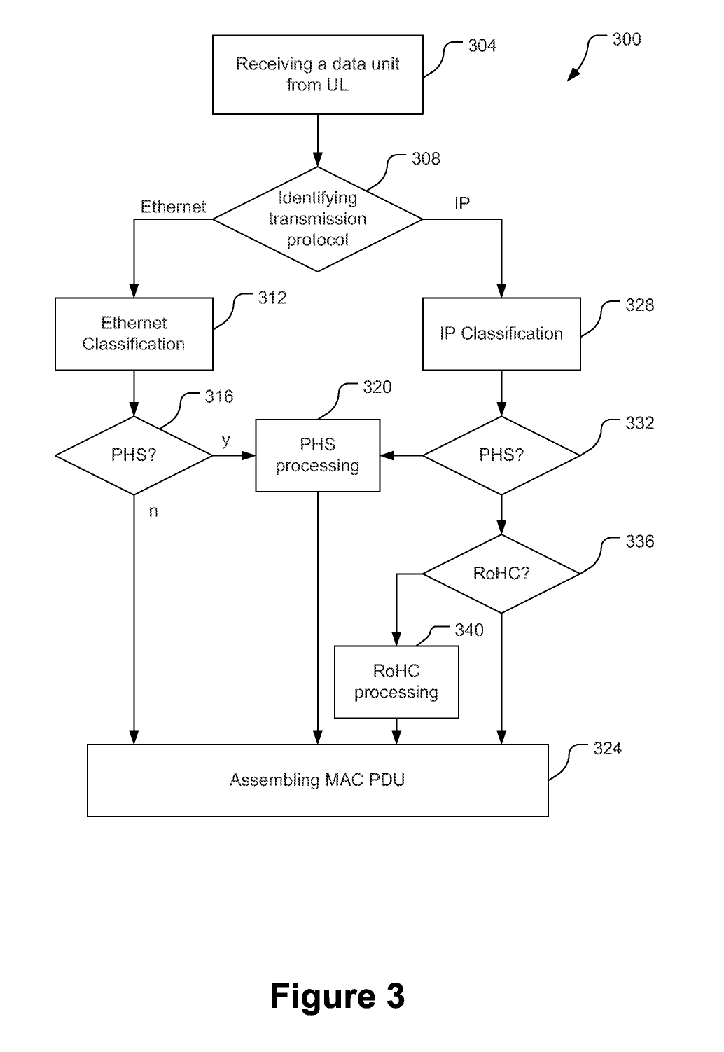

FIG. 3 illustrates a flowchart 300 of transmitter operations of a multiprotocol convergence sublayer in accordance with some embodiments. The operation may include, at block 304, receiving a data unit from a UL entity. The data unit may be an SDU.

At block 308, the operation may include identifying a transmission protocol of a particular data unit. In various embodiments, a data unit may have an IP transmission protocol or an Ethernet transmission protocol and may be arranged as an IP packet or Ethernet packet, respectively.

If it is determined, at block 308, the data unit has an Ethernet transmission protocol, the operation may advance to an Ethernet classification at block 312. The Ethernet classification may include accessing parameters of the received Ethernet packet and comparing the accessed parameters to predefined classification rules. The comparing may result in a determination of whether a header reduction process is to be used and, if so, what type. The comparing may also result in a determination of a service flow connection to which the packet is to be mapped. The Ethernet classification may include various identifiers, e.g., FID and/or header-reduction indicator, being appended to the data unit to facilitate routing of the data unit.

At block 316, it may be determined whether PHS processing is to be performed. In some embodiments, this may be determined based on a header-reduction indicator appended to the packet during the Ethernet classification at block 312. If PHS processing is to be performed, the operation may advance to PHS processing at block 320. PHS processing at block 320 may be similar to that described above with respect to the PHS suppressor 140. After PHS processing at block 320 the operation may advance to assembling MAC PDU at block 324.

If it is determined, at block 316, that PHS processing is not to be used, the operation may advance to appending Type ID at block 324. It may be that RoHC processing is not used for Ethernet packets. Therefore, it may not be necessary to do an additional determination as to whether RoHC processing is to be used after block 316.

If it is determined, at block 308, the data unit has an IP transmission protocol, the operation may advance to an IP classification at block 328. The IP classification may include accessing parameters of the received IP packet and comparing the accessed parameters to predefined classification rules. Similar to the Ethernet classification at block 312, the comparing may result in a determining of whether a header reduction process is to be used and, if so, what type, as well as a service flow connection to which the packet is to be mapped. The IP classification may include various identifiers, e.g., FID and/or header-reduction indicator, being appended to the data unit to facilitate routing of the data unit.

Following block 328, the operation may advance to block 332 at which point it may be determined whether PHS processing is to be performed on the packet. Similar to determination at block 316, the determination of block 332 may be based on a header-reduction indicator appended to the packet in accordance with some embodiments. If it is determined that PHS processing is to be performed, the operation may advance to PHS processing at block 320. However, if it is determined that PHS processing is not to be performed, the operation may proceed to block 336.

At block 336 it is determined whether RoHC processing is to be performed. Similar to determination at block 332, the determination at block 336 may be based on a header-reduction indicator appended to the packet in accordance with some embodiments. If it is determined that RoHC processing is to be performed, the operation may advance to RoHC processing at block 340. RoHC processing at block 340 may be performed in a manner similar to that described above with respect to the RoHC compressor 144. After RoHC processing at block 340 the operation may advance to assembling MAC PDU at block 324.

At block 324, a Type ID, which provides information related to the transmission protocol and/or header reduction process, may be appended to the SDU. In embodiments in which a header-reduction indicator was previously provided, for routing within components of the multiprotocol CS layer, the header-reduction indicator may be removed in favor of the Type ID. As described above, the Type ID may be one of five values in accordance with some embodiments.

Assembling MAC PDU at block 324 may further include creation and addition of an encapsulating header to facilitate communication of the data unit between network peers, e.g., MAC SAP 142 and a MAC SAP of a receiver. The MAC PDU, which may also include the FID, Type ID, and the SDU, as shown in FIG. 2, may be provided to the MAC SAP 142 and made available for lower-layer processing.

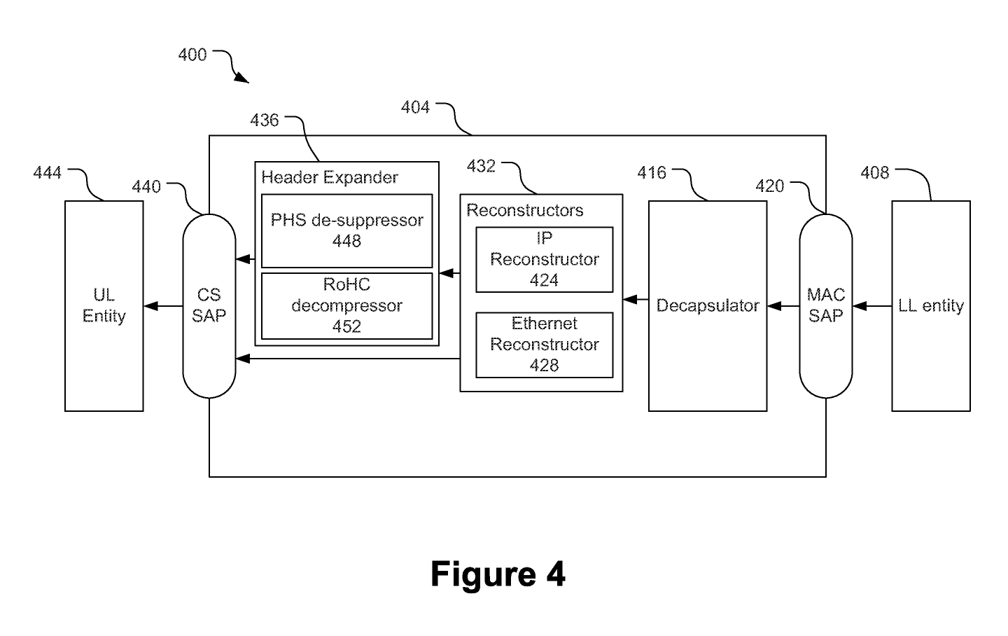

FIG. 4 illustrates a receiver 400 in accordance with some embodiments. The receiver 400 may be designed to provide operations to complement operations provided by the transmitter 100. The receiver 400 may include a CS 404 that receives data units from an LL entity 408, e.g., a MAC security layer entity, extracts information from the data units, and provides the extracted information to a UL entity 444, e.g., a bridge, a router, or a host.

The CS 404 may include a decapsulator 416 to receive, at a MAC SAP 420, data units as PDUs. The decapsulator 416 may reference a Type ID of the individual data units to determine an associated transmission protocol and transmit the data unit to the appropriate one of either an IP reconstructor 424 or an Ethernet reconstructor 428 (collectively referred to as “reconstructors 432”). In some embodiments, the decapsulator 416 may remove the Type ID from a data unit and append a header-reduction indicator to facilitate routing through the CS 404. In other embodiments, the type ID may remain appended to the data units to facilitate subsequent routing through the CS 404 and removed at a later time.

The reconstructors 432 may reconstruct the data units as protocol packets according to respective transmission protocol stacks. The reconstruction may include various packet assembling, addressing, and controlling processes.

The reconstructors 432 may determine whether a header-reduction process was performed on the data unit by referencing the header-reduction indicator or Type ID. If a header-reduction process was performed, the reconstructors 432 may transmit the data unit to a header expander 436, else the reconstructors 432 may transmit the data unit directly to a CS SAP 440, which may provide the data unit, as an SDU, to a UL entity 444.

The header expander 436 may expand a header by a header-expansion process that complements a header-reduction process implemented by the header reducer 132. The header expander 436 may include a PHS de-suppressor 448 to perform a PHS process that complements the PHS process performed by PHS suppressor 140. The PHS de-suppressor 448 may expand a previously-suppressed header of a data unit according to PHS rules established through communications with the PHS suppressor 140.

The header expander 436 may also include a RoHC decompressor 452 to perform a RoHC process that complements the RoHC process performed by the RoHC compressor 144. The RoHC decompressor 452 may expand a previously-compressed header of a data unit according to parameters established with the RoHC compressor 144 during an initial setup, IR state, and/or FO state.

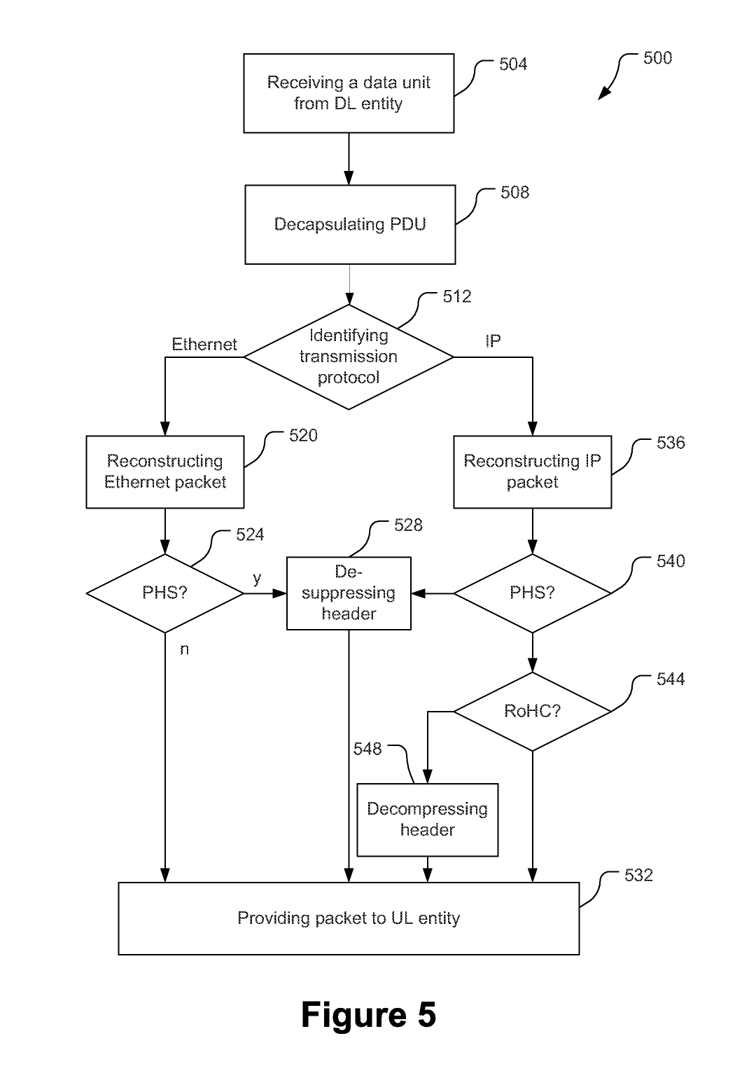

FIG. 5 illustrates a flowchart 500 of receiver operations of a multi-protocol convergence sublayer in accordance with some embodiments. The operation may include, at block 504, receiving a data unit from a DL entity. The data unit may be a PDU.

At block 508, the operation may include decapsulating a PDU. The decapsulating of the PDU may involve interpretation and removal of an encapsulating header from the PDU that was provided for successful communication of the data unit between network peers, e.g., MAC SAP 140 and MAC SAP 420.

At block 512, the operation may include identifying a transmission protocol of the data unit. The transmission protocol may be identified by referencing the Type ID appended to the data unit. If it is determined that the transmission protocol is an Ethernet protocol, the operation may advance to reconstructing an Ethernet packet at block 520. The Ethernet packet may be reconstructed through an Ethernet protocol stack.

Following reconstruction of an Ethernet packet, the operation may proceed to determining whether a PHS process had been performed on the Ethernet packet at block 524. The determining at block 524 may be accomplished by referencing a Type ID and/or header-reduction indicator. If it is determined, at block 524, that a PHS process had been performed on the Ethernet packet, the operation may advance to de-suppressing header at block 528. A header of the Ethernet packet may be de-suppressed according to pre-established PHS rules.

Following de-suppression of the header, the operation may advance to providing the packet to UL entity at block 532. The packet may be provided to the UL entity at a CS SAP. In some embodiments, a Type ID and/or header-reduction indicator may be removed at or prior to the providing of the packet to UL entity at block 532.

If, at block 524, it is determined that a PHS process had not been performed on the Ethernet packet, the operation may advance to block 532. As described above, it may be that RoHC processes are not performed on Ethernet packets; therefore, it may not be necessary to provide an additional determination, following a negative determination in block 524, as to whether a RoHC process was used.

If, at block 512, it is determined that the transmission protocol is an IP protocol, the operation may advance to reconstructing IP packet at block 520. The IP packet may be reconstructed through an IP protocol stack.

Following reconstruction of an IP packet at block 536, the operation may proceed to determining whether a PHS process had been performed on the IP packet at block 540. The determining at block 540 may be similar to determining at block 524.

If it is determined, at block 540, that a PHS process had been performed on the IP packet, the operation may advance to de-suppressing header at block 528.

If it is determined, at block 540, that a PHS process had not been performed on the IP packet, the operation may advance to determining whether a RoHC process had been performed on the IP packet at block 544. The determining at block 544 may be accomplished by referencing a Type ID and/or a header-reduction indicator. If it is determined that a RoHC process has not been performed at block 544, the operation may proceed to the providing of the packet to the UL entity at block 532.

If it is determined, at block 544, that a RoHC process had been used, the operation may advance to decompressing header at block 548. The decompression of the header may be performed according to predetermined compression parameters, e.g., parameters established with a RoHC compressor during an initial setup, an IR state, and/or an FO state.

In various embodiments, the transmitter 100 and receiver 400 may be configured to communicate according to a wireless broadband mobile access technology standard such as WiMAX (e.g., IEEE 802.16-2009) or Long-Term Evolution (LTE) (e.g., 3GPP Release 8).

The CS and its associated entities described herein may be implemented into a system using any suitable hardware and/or software to configure as desired.

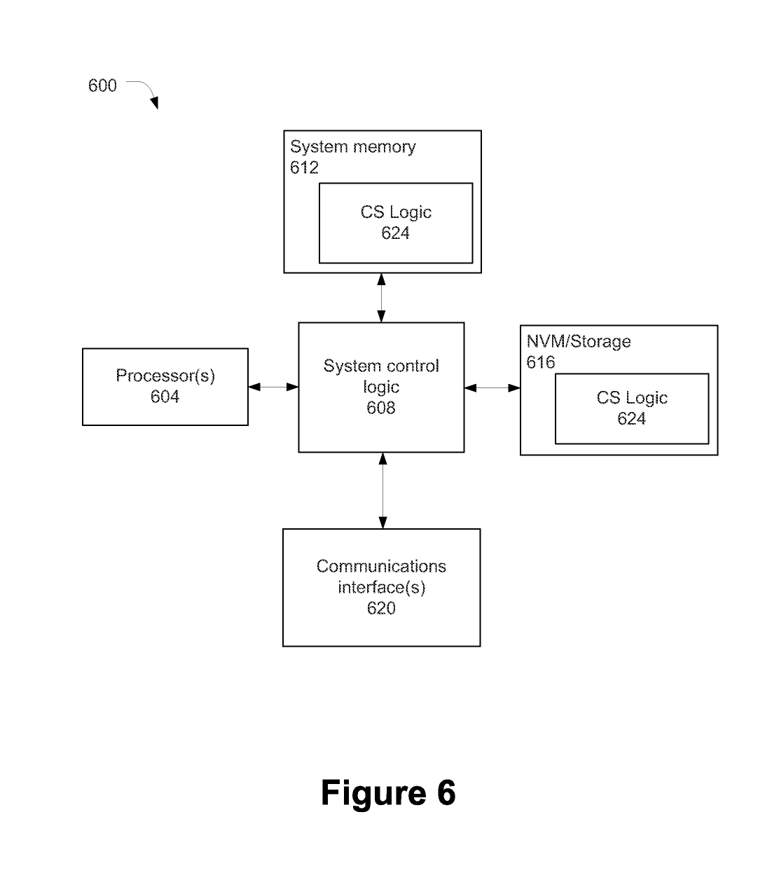

FIG. 6 illustrates, for one embodiment, an example system 600 comprising one or more processor(s) 604, system control logic 608 coupled to at least one of the processor(s) 604, system memory 612 coupled to system control logic 608, non-volatile memory (NVM)/storage 616 coupled to system control logic 608, and one or more communications interface(s) 620 coupled to system control logic 608.

System control logic 608 for one embodiment may include any suitable interface controllers to provide for any suitable interface to at least one of the processor(s) 604 and/or to any suitable device or component in communication with system control logic 608.

System control logic 608 for one embodiment may include one or more memory controller(s) to provide an interface to system memory 612. System memory 612 may be used to load and store data and/or instructions, for example, for system 600. System memory 612 for one embodiment may include any suitable volatile memory, such as suitable dynamic random access memory (DRAM), for example.

System control logic 608 for one embodiment may include one or more input/output (I/O) controller(s) to provide an interface to NVM/storage 616 and communications interface(s) 620.

NVM/storage 616 may be used to store data and/or instructions, for example. NVM/storage 616 may include any suitable non-volatile memory, such as flash memory, for example, and/or may include any suitable non-volatile storage device(s), such as one or more hard disk drive(s) (HDD(s)), one or more compact disk (CD) drive(s), and/or one or more digital versatile disk (DVD) drive(s) for example.

The NVM/storage 616 may include a storage resource physically part of a device on which the system 600 is installed or it may be accessible by, but not necessarily a part of, the device. For example, the NVM/storage 616 may be accessed over a network via the communications interface(s) 620.

System memory 612 and NVM/storage 616 may include, in particular, temporal and persistent copies of CS logic 624, respectively. The CS logic 624 may include instructions that when executed by at least one of the processor(s) 604 result in the system 600 performing CS operations described herein. In some embodiments, the CS logic 624 may additionally/alternatively be located in the system control logic 608.

Communications interface(s) 620 may provide an interface for system 600 to communicate over one or more network(s) and/or with any other suitable device. Communications interface(s) 620 may include any suitable hardware and/or firmware. Communications interface(s) 620 for one embodiment may include, for example, a network adapter, a wireless network adapter, a telephone modem, and/or a wireless modem. For wireless communications, communications interface(s) 620 for one embodiment may use one or more antennae.

For one embodiment, at least one of the processor(s) 604 may be packaged together with logic for one or more controller(s) of system control logic 608. For one embodiment, at least one of the processor(s) 604 may be packaged together with logic for one or more controllers of system control logic 608 to form a System in Package (SiP). For one embodiment, at least one of the processor(s) 604 may be integrated on the same die with logic for one or more controller(s) of system control logic 608. For one embodiment, at least one of the processor(s) 604 may be integrated on the same die with logic for one or more controller(s) of system control logic 608 to form a System on Chip (SoC).

In various embodiments, system 600 may have more or less components, and/or different architectures.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims and the equivalents thereof.

What is claimed is:

1. An apparatus comprising:
one or more classifiers configured to receive a first data unit and a second data unit from a convergence sublayer service access point (CS-SAP) and to associate both the first and second data units with a common service flow connection;
a header reducer configured to reduce a header of the first data unit according to a first header-reduction process; and
an assembler configured to:
append a first identifier to the first data unit to indicate a reduction of the header by the first header-reduction process; and
append a second identifier to the second data unit to indicate either a non-reduction of a header of the second data unit or a reduction of the header of the second data unit with a second header-reduction process that is different than the first header-reduction process.

2. The apparatus of claim 1, wherein the first identifier is to indicate a first transmission protocol associated with the first data unit and the second identifier is to indicate a second transmission protocol, different from the first transmission protocol, associated with the second data unit.

3. The apparatus of claim 2, wherein the first transmission protocol is a first one of Internet protocol or Ethernet, and the second protocol is a second one of Internet protocol or Ethernet.

4. The apparatus of claim 1, wherein the first header-reduction process is robust header compression (RoHC) process or payload header suppression (PHS) process.

5. The apparatus of claim 1, wherein the assembler is further configured to generate a protocol data unit (PDU) having the first data unit and the first identifier.

6. The apparatus of claim 1, wherein the one or more classifiers are configured to associate the first and second data unit with the common service flow connection by being configured to associate both the first and second data units with a flow identifier (FID).

7. The apparatus of claim 6, wherein the one or more classifiers include:
a first protocol classifier configured to:
receive the first data unit from the CS SAP;
append the first data unit with the FID; and
provide the first data unit to a first header reducer to implement the first header-reduction process.

8. The apparatus of claim 7, wherein the one or more classifiers further include:
a second protocol classifier configured to:
receive the second data unit from the CS SAP;
append the second data unit with the FID; and
provide the second data unit to a second header reducer to implement the first header-reduction process or to the assembler.

9. The apparatus of claim 1, wherein the first and second identifiers are selected from five type identifiers (Type IDs), wherein a first Type ID indicates Internet protocol (IP) transmission protocol with no header reduction; a second Type ID indicates IP transmission protocol with robust header compression (RoHC) process; a third Type ID indicates IP transmission protocol with payload header suppression (PHS) process; a fourth Type ID indicates Ethernet transmission protocol with no header reduction; and a fifth Type ID indicates Ethernet transmission protocol with PHS process.

10. A method comprising:
receiving, at a multiprotocol convergence sublayer, a data unit;
appending, by the multiprotocol convergence sublayer, a type identifier (Type ID) to the data unit to identify a transmission protocol and a first header-reduction process associated with the data unit; and
mapping, by the multiprotocol convergence sublayer, the data unit to a service flow connection.

11. The method of claim 10, further comprising:
mapping, by the multiprotocol convergence sublayer, another data unit to the service flow connection, wherein the other data unit is either not associated with any header-reduction process or is associated with another header-reduction process that differs from the header reduction process associated with the data unit.

12. The method of claim 11, wherein the header-reduction process associated with the data unit is a robust header compression process.

13. The method of claim 12, wherein the other header-reduction process is a payload header suppression process.

14. The method of claim 10, further comprising:
referencing, by one or more classifiers of the multiprotocol convergence sublayer, a parameter in the data unit; and
mapping the data unit to the service flow connection based on the referencing of the parameter.

15. The method of claim 10, wherein mapping the data unit comprises:
appending, to the data unit, a flow identifier associated with the service flow connection.

16. The method of claim 10, further comprising:
classifying the data unit with a protocol classifier that corresponds to the transmission protocol.

17. A non-transitory, computer-readable medium having associated instructions that, if executed, cause a receiver to:
access a first type identifier (Type ID) associated with a first data unit of a service flow connection;
identify a transmission protocol associated with the first data unit based on said access of the first Type ID; and
identify a header reduction process by which a header of the first data unit was reduced based on said access of the first Type ID.

18. The non-transitory, computer-readable medium of claim 17, wherein the instructions, if executed, further cause the receiver to:
access a second Type ID associated with a second data unit of the service flow connection;
identify another transmission protocol associated with the second data unit based on said access of the second Type ID; and
identify, based on said access of the second Type ID, either another header reduction process by which a header of the second data unit was reduced or that no header-reduction process was used on the second data unit.

19. The non-transitory, computer-readable medium of claim 18, wherein the transmission protocol is a first one of Internet protocol or Ethernet, and the other transmission protocol is a second one of Internet protocol or Ethernet.

20. The non-transitory, computer-readable medium of claim 17, wherein the instructions, if executed, further cause the receiver to:
process the data unit according to the transmission protocol; and
expand the header by a header-expansion process that complements the header-reduction process.

21. A system comprising:
a communication interface to communicatively couple the system to a wireless network; and
convergence sublayer logic configured to:
transmit, via the communication interface in a dynamic service addition (DSA) message and/or a dynamic service change (DSC) message, one or more multiprotocol convergence sublayer policy (MCP) bits for each of a plurality of classification rules, wherein the MCP bits are configured to provide information about header reduction for a respective classification rule; and
transmit a first data unit that matches a first classification rule of the plurality of classification rules over a service flow connection and transmit a second data unit that matches a second classification rule of the plurality of classification rules over the service flow connection.

22. The system of claim 21, wherein the convergence sublayer logic is further configured to transmit an exclusion condition flag to indicate whether header-reduction processes are defined on a per-classification-rule basis, or on a per-service-flow basis.
